(19) United States
(12) Patent Application Publication
(10) Pub. No.: US 2017/0267303 A1
(43) Pub. Date: Sep. 21, 2017

(54) BRAKE LIGHT DEVICE

(71) Applicant: SIGMA Sport USA, L.L.C., St. Charles, IL (US)

(72) Inventor: Klaus-Peter Schendel, Neustadt (DE)

(21) Appl. No.: 15/075,523

(22) Filed: Mar. 21, 2016

(51) Int. Cl. B62J 6/04; B62J 6/16

(52) U.S. Cl. CPC B62J 6/04; B62J 6/16; B62J 2700/636

(57) ABSTRACT

A bicycle brake light configured for attaching to a bicycle braking system such that the brake light illuminates when the braking system is activated. The devices includes a rotating switch which operates to turn on a light when the bicycle brake is operated through mechanical interaction with elements of a Bowden cable.

### BACKGROUND OF THE INVENTION

Field of the Invention

This disclosure pertains to the field of recreational safety, and more particularly to a brake light device for use with mechanical braking systems.

Description of the Related Art

In 2013, an estimated 743 bicyclists were killed in crashes with motor vehicles. Although traffic fatalities for motorists and motor vehicle passengers have declined over the last ten years, fatalities for bicyclists have remained steady. According to statistics reported by the U.S. Department of Transportation, almost half of all bicycle fatalities take place in the evening.

Bicycles are typically sold with reflectors positioned at various angles to reflect illumination from a vehicle's headlamps and alert drivers to the presence of a cyclist. However, reflectors only work properly under specific conditions. If a reflector is located outside the beam of the headlamps, no light will reflect. Further, if the entrance angle of a reflector has been disturbed, such as by bumping or tilting the reflector, the optical performance of the reflector may be impaired. Reflectors are frequently disturbed, such as in routine repairs and even falls and other accidents, but are rarely reset to their proper position.

Further, the observation angle of the reflector may be insufficient to reach the driver, particularly for larger vehicles where the entrance angle and observation angle may differ substantially due to the driver's seat being higher above the road. The vehicle may also have a burned-out headlamp, eliminating the opportunity for reflection at all. The headlamp itself may also be obscured, reducing its performance and thereby impairing the optical performance of the reflector. Similarly, the reflector itself may be obscured, such as after the bicycle has traveled through mud or fouled water. Further, environmental conditions, such as humidity, precipitation, and fog, may further impair reflector performance.

Thus, bicyclists are encouraged to use additional forms of safety illumination that do not depend upon the presence of an eternal light source. It is increasingly common to augment off-the-rack bicycles with supplementary lighting systems. These systems typically provide a light source mounted on the bicycle, eliminating the need for reflection. The light source may be powered by the mechanical activity of the bicycle itself, or by a power source such as a battery, which may be in turn be charged by mechanical action, a solar collector, and the like. Such lighting systems improve safety. Thus, the U.S. Department of Transportation recommends a flashing red rear light for use with a bicycle at night.

However, these lighting systems indicate only the presence of a bicycle, not the behavior of the bicycle. If a bicyclist is slowing or braking, the light provides no indication. For conventional motor vehicle drivers, who are accustomed to seeing brake lights when a vehicle is braking, the absence of this visual cue may be dangerous because bicycles, like motorcycles, are easy to overlook in busy streets. This may lead to additional collisions, injuries, and loss of life as vehicles rear-end braking bicyclists. While cities have increasingly begun to use bicycle lanes to improve traffic safety, the lack of brake lighting remains a problem, as collisions among bicyclists may also occur in crowded bicycle lanes and in competitive bicycling activities, resulting in damage, injury, and even loss of life.

However, adding brake lights to a bicycle is not simple. Most bicycle brakes are operated by hand using a lever or other actuation means disposed near the handles. The rider indicates the desire to brake by operating the hand lever squeezing or pulling. This action generates a mechanical signal, which is then transmitted to the braking system, typically through a Bowden cable, hydraulics, or a rod system. The braking system receives the signal and brakes the bicycle, usually by activating a caliper or drum which presses against a braking surface of the bicycle, such as the wheel rim, to slow it down via friction (i.e., converting the kinetic energy of the bicycle into thermal energy, which is dissipated into the environment).

However, unlike a motor vehicle, a bicycle typically does not have an integrated electrical system, and adding an after-market brake light is not straightforward. The light is most effective if it operates in synchrony with braking of the bicycle and does not operate when the bicycle is not braking. However, the mechanical systems of a bicycle brake are generally self-contained, and many bicyclists are reluctant to modify the braking system due to the high risk of a dangerous accident if the brakes are accidentally rendered inoperable. What is needed in the art is a simple after-market bicycle brake light which can be attached to a bicycle without extensive modification of the existing brake system.

### SUMMARY OF THE INVENTION

The following is a summary of the invention in order to provide a basic understanding of some aspects of the invention. This summary is not intended to identify key or critical elements of the invention or to delineate the scope of the invention. The sole purpose of this section is to present some concepts of the invention in a simplified form as a prelude to the more detailed description that is presented later.

Because of these and other problems in the art, described herein, among other things, is a bicycle brake light configured for attaching to a bicycle braking system such that the brake light illuminates when the braking system is activated. Generally speaking, the depicted device comprises a component for attaching the device to the bicycle and/or braking system, a light, and a component for activating the light when the braking system is activated.

Because of these and other problems in the art, described herein, among other things, is a brake light device comprising: a base comprising: an electric light disposed thereon; a rotating switch detachable from the base; a recess sized and shaped to accept the rotating switch; an electric power source; and an electric circuit electrically connecting the electric light to the power source via the rotating switch in a closed circuit when the rotating switch is disposed in the recess in a first position; a shell comprising: a top having a distal end and an opposing proximal end, the distal end comprising a channel sized and shaped for accepting a braking cable; a side rigidly attached to the top, the side having a hole therethrough sized and shaped to accept the rotating switch, the hole corresponding to the recess when the shell is disposed on the base such that the rotating switch is disposable in the recess through the hole to rotatably connect the shell to the base; wherein when the shell is rotatably connected to the base via the rotating switch disposed in the recess through the hole, the rotating switch rotates to the first position and thereby closes the electric circuit when the shell rotates toward the base.

In an embodiment of the brake light device, the rotating switch is disc-shaped, the recess is round, and the hole is round.

In an embodiment of the brake light device, the electric power source is a replaceable chemical battery.

In an embodiment of the brake light device, when the shell is rotatably connected to the base by the rotating switch, the shell is rotatable to an open position in which the distal end of the shell is remote from the base, and the shell is rotatable to a closed position in which the distal end of the shell is proximate to the base.

In an embodiment of the brake light device, when the shell is rotated to the open position, the rotating switch rotates out of the first position and thereby opens the electrical circuit, causing no current to flow from the electric power source to the electric light.

In an embodiment of the brake light device, the shell is further sized and shaped such that at least part of the shell covers the electric light.

In an embodiment of the brake light device, when the shell is rotated to the closed position, the rotating switch rotates to the first position and thereby closes the electrical circuit, causing current to flow from the electric power source to the electric light.

In an embodiment of the brake light device, the device further comprises a mechanical resistor disposed between the base and the shell such that the mechanical resistor forces the shell to rotate to the open position.

In an embodiment of the brake light device, the mechanical resistor is a coil spring.

In an embodiment of the brake light device, the base further comprises a channel sized and shaped to accept a braking cable and disposed on the base to align with the shell channel, such that a linear braking cable is disposable through the base channel and the shell channel.

In an embodiment of the brake light device, the base further comprises a means for removably and fixedly attaching the base to a bicycle brake cable.

Also described herein, among other things, is a method for providing a visual alert when a bicycle brakes, comprising: providing a bicycle having a braking system comprising: two braking calipers disposed on opposing sides of a wheel rim of the bicycle and operable to compress the rim between the two braking calipers to brake the bicycle; a hand lever operably connected to the two braking calipers via a Bowden cable, the Bowden cable comprising an outer cable terminating at and connected to a first of the two braking calipers, and an inner cable disposed partially within the outer cable and having an exposed portion extending beyond the outer cable and terminating at and connected to a second of the two braking calipers, such that when the hand lever is operated, the exposed portion and the outer cable move toward each other and thereby operate the two braking calipers; providing a brake light device comprising a base having a light electrically connectable to a power source via a rotating switch, the rotating switch rotatably connecting to the base a shell having a channel sized and shaped to accept the inner cable; fixedly attaching the base to the exposed portion of the inner cable at the terminating of the outer cable, wherein the outer cable is adjacent to the shell, the light is visible from a position rearward of the bicycle, and the exposed portion passes through the channel; operating the hand lever; moving the exposed portion toward the outer cable through the channel; the outer cable rotating the shell; the shell rotating the rotating switch to a position that electrically connects the light to the power source; the power source illuminating the light.

In an embodiment of the method, the method further comprises: the brake light device further comprising a mechanical resistor disposed between the base and the shell, the resistor resisting rotation of the shell toward the base; releasing the hand lever; moving the exposed portion away from the outer cable through the channel; the mechanical resistor rotating the shell; the shell rotating the rotating switch to a position that electrically disconnects the light from the power source; the light discontinuing illumination.

### BRIEF DESCRIPTION OF THE DRAWINGS

FIG. 1 depicts an isometric view of an assembled brake light device according to the present disclosure.

FIG. 2 depicts an isometric exploded view on a brake light device according to the present disclosure.

FIG. 3 depicts an alternative isometric exploded view of a brake light device according to the present disclosure.

FIGS. 4A and 4B depict a rear view of a brake light device according to the present disclosure installed on a bicycle braking system in the off and on positions, respectively.

FIGS. 5A and 5B depict a front view of a brake light device according to the present disclosure installed on a bicycle braking system in the off and on positions, respectively.

FIG. 6 depicts a brake light device according to the present disclosure installed on a bicycle braking system and in mechanical communication with a hand lever.

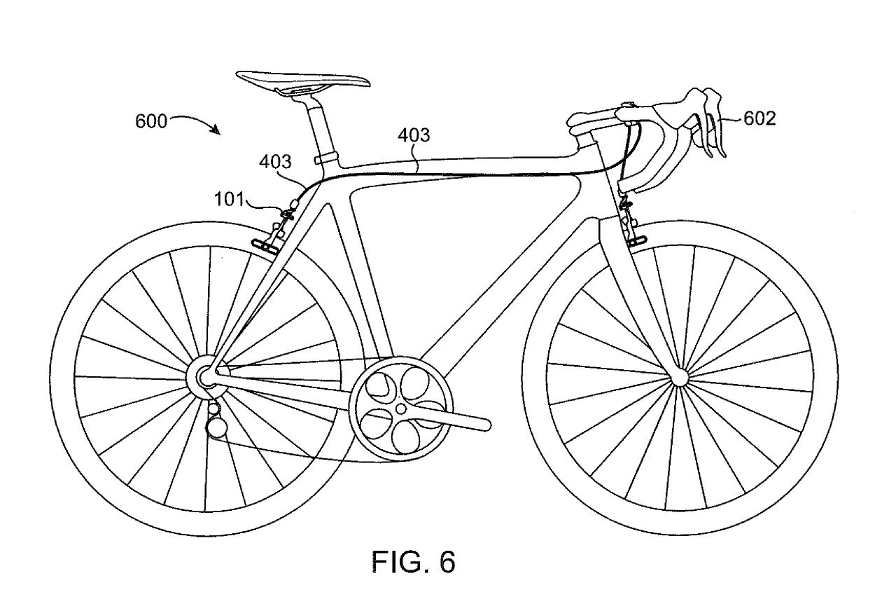

### DESCRIPTION OF THE PREFERRED EMBODIMENT(S)

The following detailed description and disclosure illustrates by way of example and not by way of limitation. This description will clearly enable one skilled in the art to make and use the disclosed systems and methods, and describes several embodiments, adaptations, variations, alternatives and uses of the disclosed systems and methods. As various changes could be made in the above constructions without departing from the scope of the disclosures, it is intended that all matter contained in the description or shown in the accompanying drawings shall be interpreted as illustrative and not in a limiting sense.

Because of these and other problems in the art, described herein, among other things, is a bicycle (600) brake light device (101) configured for attaching to a bicycle (600) braking system (401) such that the brake light device (101) illuminates when the braking system (401) is activated. Generally speaking, the depicted device (101) comprises a component for attaching the device (101) to the bicycle (600) and/or braking system (401), a light (107), and a component for activating the light (107) when the braking system (401) is activated.

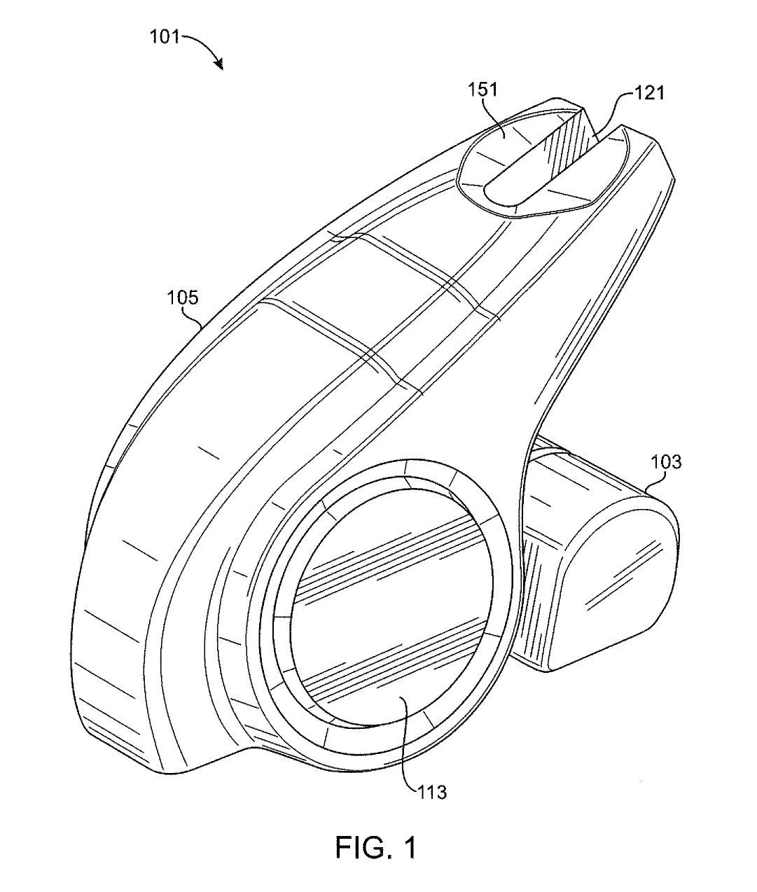

In the depicted embodiment of FIG. 1, the device (101) comprises a base (103), an attachable shell (105), and a rotating switch (113), wherein activation of the bicycle (600) braking system (401) causes the shell (105) to rotate with respect to the base (103) as explained in more detail elsewhere herein. Due to the mechanical connection of the shell (105) to the base (103) via the rotating switch (113), the rotation powers a circuit to connect the light (107) to a power source (117) and thereby illuminates the light (107). When the bicycle (600) braking system (401) is deactivated, the shell (105) rotates back via a resistance element (137), breaking the circuit and causing the light (107) to turn off. These and other components of the device (101) are described with further detail herein.

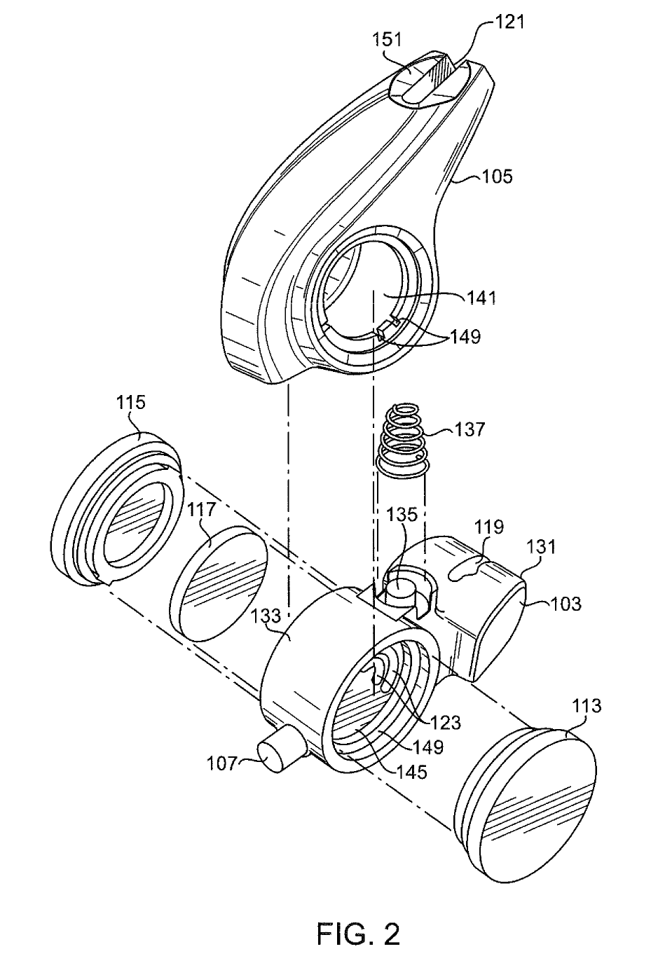

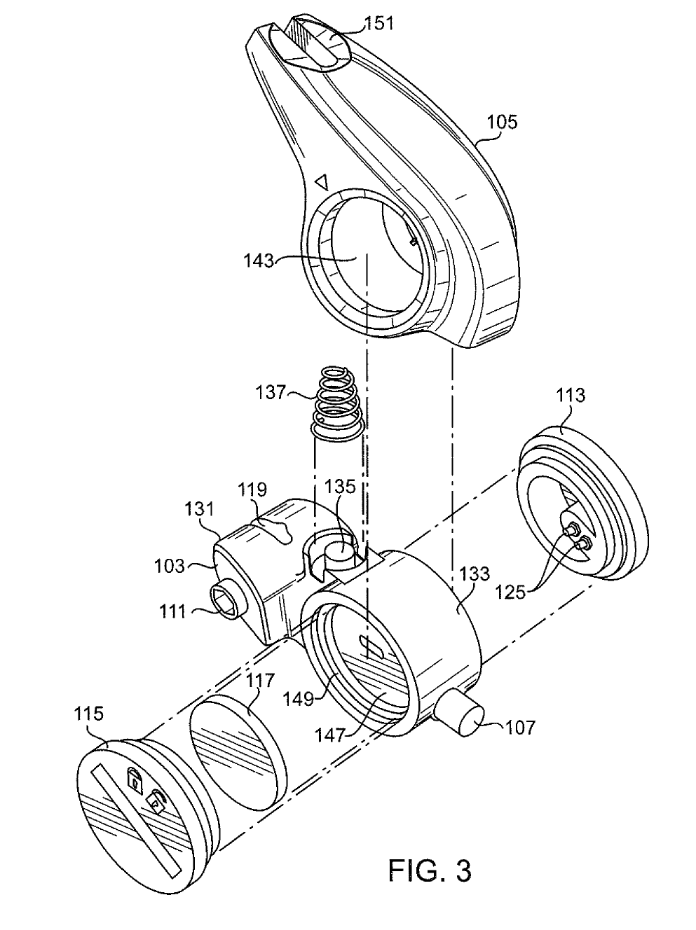

FIG. 1 depicts an embodiment of an assembled brake light device (101) according to the present disclosure. FIGS. 2-3 depict an exploded view of the same embodiment. In the depicted embodiment, the base (103) and shell (105) are separable components mechanically fastened together via a rotating switch (113) and battery cap (115) disposed on opposing sides of the base (103). The depicted base (103) includes a light source (107) disposed thereon and/or therein, but it should be noted that this is not a necessary configuration and, in an alternative embodiment, the light source (107) may be disposed external to the base (103).

The mechanical attachment of the base (103) and shell (105) can be more clearly seen in FIGS. 2-3. The depicted base (103) comprises three component elements, generally constructed as a monolithic whole. The depicted base (103) comprises an element (131) sized, shaped, and configured for attaching the device (101) to a braking system (401). This element (131) will be referred to herein as the “attaching element” (131). In the depicted embodiment, the attaching element (131) is a roughly cylindrical component with a channel (119) disposed therethrough. The depicted channel (119) is a generally narrow and linear element and passes through the majority of the body of the attaching element (131). The depicted channel (119) is disposed generally perpendicularly to the major axis of the attaching element (131).

The channel (119) is generally sized, shaped, configured, and disposed to facilitate attaching the device (101) to an element of the braking system (401). Because the purpose of the device (101) is to provide a visual notification that the bicycle (600) is braking, the device (101) is typically disposed such that the light (107) is visible from an observation point behind the bicycle (600). The channel (119) is thus generally sized, shaped, configured, and disposed such that the device (101) can be attached to the rear of a bicycle (600).

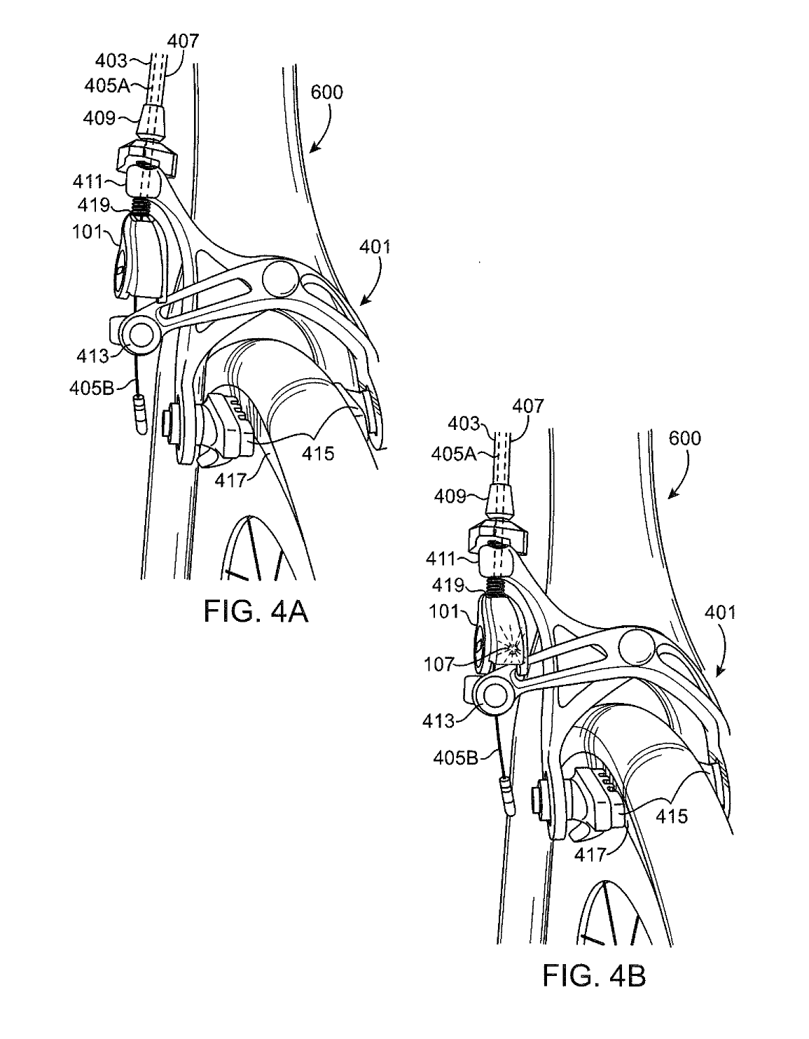

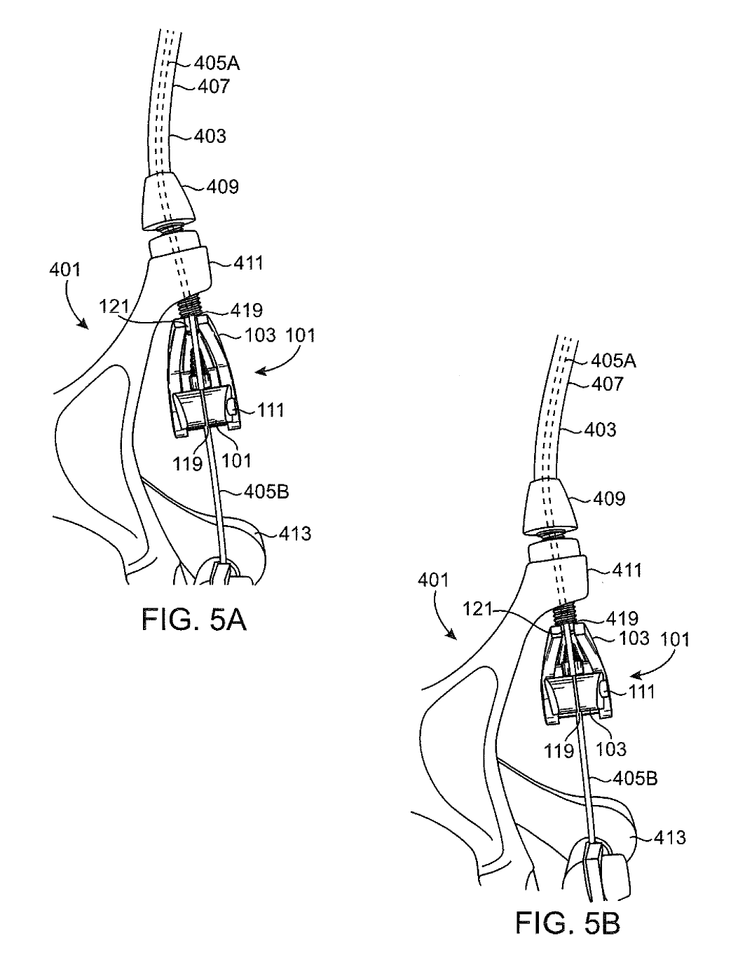

By way of example and not limitation, and as depicted in FIGS. 4A, 4B, 5A, SB, and 6, many bicycles (600) use Bowden cables (403) to mechanically transmit the operation of the hand lever (602) to the braking system (401). One of ordinary skill in the art will understand that a Bowden cable (403) is essentially a flexible cable for transmitting mechanical force or energy by the movement of an inner cable (405A) within, and relative to, a hollow outer cable (407) housing. For a bicycle (600) braking system (401), the outer cable housing (407) generally terminates (409) at or near, and is operably attached to, a first braking caliper (411), with a portion of the inner cable (405B) extending beyond the termination (409) of the outer cable housing (407) and the components attaching the outer cable (407) to the first caliper (411). The extended inner cable (405B) is also operably attached to a second braking caliper (413). Each of the first (411) and second (413) braking calipers is disposed on the bicycle (600) with opposing braking elements (415), such that when the hand lever (602) is pulled, the motion transmitted along the inner cable (405A) and (405B) causes the calipers (411) and (413) to compress the wheel rim (417) or another element of the bicycle (600) with the braking elements (415), causing the bicycle (600) to brake. In the depicted embodiment, the channel (119) is sized, shaped, configured, and disposed such that the device (101) may attached to the exposed portion of the inner cable (405B) of the Bowden cable (403) between the calipers (411) and (413).

In an embodiment, the attaching element (131) may further comprise an attaching mechanism or means (111) for holding the device (101) on the cable (405B). In the depicted embodiment, this mechanism or means (111) is an adjustable fastener (111) disposed through a hole in the attaching element (131). The depicted hole and fastener (111) are threaded and configured for interlocking, such that, if the fastener (111) is rotated, it tightens. The hole and fastener (111) are generally disposed parallel to, and may be generally coaxial with, the major axis of the attaching element (131). This is not required, however, and the hole and fastener (111) may be disposed in any configuration suitable for providing a tightening or attaching mechanism or means for attaching the device (101) to the cable (405B). The fastener (111) may be held in place via a locking nut disposed within the attaching element (131) along the hole.

A second element (133) of the base (103) is an element (133) for activating the light (107). This element (133), referred to herein as the “switching element” (133), generally comprises a switching circuit which, when operated, causes the light (107) to illuminate. In the depicted embodiment, the light (107) is an electric light, such as an LED or other lighting technology sufficiently durable to withstand the rigors of bicycle (600) travel. The depicted light (107) is embedded or included in the switching element (133), but, in alternative embodiments, the light (107) may be disposed elsewhere on, or external to, the base (103).

The light (107) is generally in electronic communication with other electrical components via a wired circuit. In the depicted embodiment, the circuit is built into the structure of the base (103), and comprises the light (107) and the power source (117). In the depicted embodiment, the power source (117) is a small replaceable battery (117). The depicted battery (117) is disposed within a first recessed area (147) of the base (103) and, when so disposed, is in electrical communication with the circuit, providing power to the circuit. The power supply (117) may be held in place by a cap (115) configured to removably but firmly attach to the base (103).

One of ordinary skill in the art will understand that an electric switch is a component that can break an electrical circuit, such as by interrupting the current or diverting it from one conductor to another. In the depicted embodiment, the device (101) includes a mechanical switch (113) operable by rotation. The rotating switch (113) comprises a plurality of prongs (125) extending therefrom. The prongs (125) are in electric communication with each other within the rotating switch (125). As can be seen in FIG. 2, the circuit is mostly contained within the structure of the base (103), with two exposed conductive elements (123) breaking the circuit. the depicted conductive elements (123) are generally in the configuration of concentric minor arcs, disposed in a recessed portion (145) of switching element (133). The depicted circuit is completed when the rotating switch (113) is disposed in the recessed portion (145) and rotated such that the prongs (125) of the rotating switch (113) are in contact with corresponding conductive elements (123). When the rotating switch (113) is rotated a sufficient amount, the prongs (125) cease to be in contact with the conductive elements (123), breaking the circuit.

The recessed area (145) is generally sized and shaped to snugly accommodate the rotating switch (113), and the rotating switch (113) may further comprise a grommet or gasket which may provide a snug fit and provide moisture-and weather-proofing aspects. The rotating switch (113) is sized and shaped to be rotatably disposed within the recessed area (145). When the device (101) is fully assembled, as discussed elsewhere herein, pressure exerted on the shell (105) is transferred to the rotating switch (113), causing the rotating switch (113) to rotate in the recessed area (145), and causing the prongs (125) to contact the conductive elements (123), thereby completing the circuit and causing the light (107) to light with current from the power supply (117).

A third element of the base (103) is a component for attaching a resistance element (137). A purpose of the resistance element (137) is to hold the shell (105) in “open” position, leaving the circuit broken and the light (107) unlit under normal operating conditions. This prevents gravity from pulling the shell (105) down to complete the circuit, or bumps from bicycle (600) operation from intermittently causing unwanted lighting. The resistance element (137) also causes the shell (105) to open up (again, breaking the circuit) when the bicycle (600) operator discontinues operating the hand lever (602), relieving pressure on the shell (105) from the Bowden cable (403) (or other mechanical transmission means). In the depicted device (103), the resistance element (137) is a coil spring, but other suitable structures are possible, such as a foam element, rubber, levers, Belleville washers, or hydraulics.

In the depicted embodiment, the shell (105) is a separate structure from the base (103) and attachable thereto. In the depicted embodiment, the shell (105) may be mechanically fastened to the base (103) via the rotating switch (113). The depicted shell (105) has a generally round opening (141) sized and shaped to accommodate the rotating switch (113). The shell (105) is attached to the base (103) by disposing the shell (105) over the base (103) and aligning the opening (141) with the recessed area (145) containing the conductive elements (123), such that the opening (141) is generally concentric with the recessed area (145). The rotating switch (113) is then disposed in the recessed area (145) through the aligned opening (141) and attached to the base (103).

The shell (105) is generally sized and shaped to mostly cover the base (103), thereby providing protection from the elements. The shell (105) may also be sized and shaped to accommodate different installation locations on the bicycle (600). In the depicted embodiment, the channel (121) end of the shell (105) further comprises a recessed element, or indentation around channel (121). This recessed or indented portion (151) is generally sized and shaped to correspond to the shape of a terminal component (419) of the cable (403) to which the device (101) is attached, so that when the cable (403) is operated and the terminal end (419) contacts the shell (105), the terminal end (419) fits generally into the recessed area (151) near the channel, facilitating operation of the device (101) and reducing slippage.

The opposing end of the depicted shell (105) is generally rounded and configured such that the shell (105) covers and protects the light (107) whether in open (e.g., FIGS. 4A and 5A) or closed (e.g., FIGS. 4B and 5B) position. In such an embodiment, the shell (105) is generally transparent or translucent and acts as a diffusing element, causing the emitted light to scatter, and thereby providing greater visibility. In an alternative embodiment (not depicted), the opposing end of the shell (105) covers and protects the light only when the shell (105) is open, but when the shell (105) is closed (e.g., compressed), the portion of the shell (105) covering the light (107) rotates upward to expose the light (107).

When the base (103), shell (105), and rotating switch (113) are fastened, the rotating switch (113) facilitates the rotation of the shell (105) with respect to the base (103). Such rotation is generally around an axis generally perpendicular to the major plane of the rotating switch (113) and passing through about the center of the rotating switch (113).

In the depicted embodiment, the rotating switch (113) is sized, shaped, and configured to move with the shell (105) when the shell (105) is rotated with respect to the base (103). That is, when the shell (105) rotates with respect to the base (103), the rotating switch (113) also rotates with respect to the base (103). This rotation is effected through mechanical attachment. In the depicted embodiment, mechanical attachment is achieved by use of ridges (149) around the opening (101), which interlock with corresponding structures on the rotating switch (113). Thus, when the shell (105) is compressed/rotated toward the base (103), the prongs (125) slide into contact with the conductive elements (125), completing the circuit and supplying power to the light (107). When the shell (105) is uncompressed/rotated away from the base (103), the prongs (125) slide out of contact with the conductive elements (123), breaking the circuit and turning off the light (107).

Generally, to further facilitate the rotation of the shell (105) with respect to the base (103), the side of the base (103) opposing the rotating switch (113) comprises the recessed area (147) for the power supply (117). The shell (105) further comprises a second opening (143) opposing the first opening (141), the second opening (143) being sized, shaped, configured, and disposed on the shell (105) such that, when the shell (105) is disposed over the base (103) for fastening the rotating switch (113), the second opening (143) is disposed over the recessed area (147) for the power supply (117). The cap (115) may then be disposed through the second opening (143) in the shell (105) and attached to the base (103) to hold the power supply (117) in place, thereby providing a second point of rotational connection of the shell (105) to the base (103). The rotational axis is also generally perpendicular to the major plane of the cap (115) when attached, and passes through about the center of the cap (115). The cap (115) and rotating switch (113) are similarly sized and shaped in the depicted embodiment, and are disposed generally concentrically on opposing sides of the base (103) to provide two corresponding points of rotational connection between the shell (105) and the base (103).

As described elsewhere herein, and as depicted in FIGS. 4A, 4B, 5A and 5B, in the depicted embodiment, when the depicted device (101) is attached to the bicycle (600) braking system (401), the device (101) generally is attached to the exposed portion (405B) of the inner cable of the Bowden cable (403). To cause the light (107) to operate in conjunction with the cyclist's operation of the hand lever (602), the shell (105) further comprises a channel (121) on an end generally opposite openings (141) and (143), i.e., generally opposite the point of mechanical connection between the shell (105) and the base (103). The shell (105) and base (103) are generally configured such that, when assembled, their respective channels (119) and (121) are vertically aligned. Thus, when the device (101) is attached to a cable (405B) disposed within channel (119), the cable (405B) further passes through the channel (121) of the shell (105). This provides additional stability to the installation and facilitates operation of the device (101) in conjunction with braking action.

The dimensions of the base (103) and shell (105) are also generally configured so that, when the device (101) is installed and in the open position, the top of the shell (105) is adjacent to, or nearly adjacent to, a termination point (411) of the outer Bowden cable (407) at a first braking caliper (411). Thus, when the hand lever (602) is operated and the inner cable (405A) and (405B) moves, the shell (105) is compressed toward the base (103) and moves to the “closed” position. This in turn causes the rotating switch (113) to rotate, which in turn causes the prongs (125) to contact the conductive elements (123), completing the circuit and illuminating the light (107). When the hand lever (602) is released, the resistance element (137) applies reverse pressure to the shell (105), moving the device (101) back to the “open” position. This again causes the rotating switch (113) to move with respect to the base (103) such that the prongs (125) are not in contact with the conductive elements (123), breaking the circuit and turning off the light (107).

While this invention has been disclosed in connection with certain preferred embodiments, this should not be taken as a limitation to all of the provided details. Modifications and variations of the described embodiments may be made without departing from the spirit and scope of this invention, and other embodiments should be understood to be encompassed in the present disclosure as would be understood by those of ordinary skill in the art.

1. A brake light device comprising:
a base comprising:
an electric light disposed thereon;
a rotating switch detachable from said base;
a recess sized and shaped to accept said rotating switch;
an electric power source; and
an electric circuit electrically connecting said electric light to said power source via said rotating switch in a closed circuit when said rotating switch is disposed in said recess in a first position;
a shell comprising:
a top having a distal end and an opposing proximal end, said distal end comprising a channel sized and shaped for accepting a braking cable;
a side rigidly attached to said top, said side having a hole therethrough sized and shaped to accept said rotating switch, said hole corresponding to said recess when said shell is disposed on said base such that said rotating switch is disposable in said recess through said hole to rotatably connect said shell to said base;
wherein when said shell is rotatably connected to said base via said rotating switch disposed in said recess through said hole, said rotating switch rotates to said first position and thereby closes said electric circuit when said shell rotates toward said base.

2. The brake light device of claim 1, wherein said rotating switch is disc-shaped, said recess is round, and said hole is round.

3. The brake light device of claim 1, wherein said electric power source is a replaceable chemical battery.

4. The brake light device of claim 1, wherein when said shell is rotatably connected to said base by said rotating switch, said shell is rotatable to an open position in which said distal end of said shell is remote from said base, and said shell is rotatable to a closed position in which said distal end of said shell is proximate to said base.

5. The brake light device of claim 4, wherein when said shell is rotated to said open position, said rotating switch rotates out of said first position and thereby opens said electrical circuit, causing no current to flow from said electric power source to said electric light.

6. The brake light device of claim 5, wherein said shell is further sized and shaped such that at least part of said shell covers said electric light.

7. The brake light device of claim 6, wherein when said shell is rotated to said closed position, said rotating switch rotates to said first position and thereby closes said electrical circuit, causing current to flow from said electric power source to said electric light.

8. The brake light device of claim 4, said device further comprising a mechanical resistor disposed between said base and said shell such that said mechanical resistor forces said shell to rotate to said open position.

9. The brake light device of claim 8, wherein said mechanical resistor is a coil spring.

10. The brake light device of claim 4, wherein said base further comprises a channel sized and shaped to accept a braking cable and disposed on said base to align with said shell channel, such that a linear braking cable is disposable through said base channel and said shell channel.

11. The brake light device of claim 10, wherein said base further comprises a means for removably and fixedly attaching said base to a bicycle brake cable.

12. A method for providing a visual alert when a bicycle brakes, comprising:
providing a bicycle having a braking system comprising:
two braking calipers disposed on opposing sides of a wheel rim of said bicycle and operable to compress said rim between said two braking calipers to brake said bicycle;
a hand lever operably connected to said two braking calipers via a Bowden cable, said Bowden cable comprising an outer cable terminating at and connected to a first of said two braking calipers, and an inner cable disposed partially within said outer cable and having an exposed portion extending beyond said outer cable and terminating at and connected to a second of said two braking calipers, such that when said hand lever is operated, said exposed portion and said outer cable move toward each other and thereby operate said two braking calipers;
providing a brake light device comprising a base having a light electrically connectable to a power source via a rotating switch, said rotating switch rotatably connecting to said base a shell having a channel sized and shaped to accept said inner cable;
fixedly attaching said base to said exposed portion of said inner cable at said terminating of said outer cable, wherein said outer cable is adjacent to said shell, said light is visible from a position rearward of said bicycle, and said exposed portion passes through said channel;
operating said hand lever;
moving said exposed portion toward said outer cable through said channel;
said outer cable rotating said shell;
said shell rotating said rotating switch to a position that electrically connects said light to said power source;
said power source illuminating said light.

13. The method of claim 12 further comprising:
said brake light device further comprising a mechanical resistor disposed between said base and said shell, said resistor resisting rotation of said shell toward said base;
releasing said hand lever;
moving said exposed portion away from said outer cable through said channel;
said mechanical resistor rotating said shell;
said shell rotating said rotating switch to a position that electrically disconnects said light from said power source;
said light discontinuing illumination.
